(19) United States
(12) Patent Application Publication
(10) Pub. No.: US 2026/0088959 A1
(43) Pub. Date: Mar. 26, 2026

(54) COMMUNICATION METHOD AND APPARATUS

(71) Applicant: HUAWEI TECHNOLOGIES CO., LTD., Shenzhen (CN)

(72) Inventors: Ruonan Yang, Shenzhen (CN); Ying Chen, Hangzhou (CN); Xiaolu Wang, Hangzhou (CN); Yunfei Qiao, Hangzhou (CN); Yinggang Du, Shenzhen (CN); Jun Wang, Hangzhou (CN)

(73) Assignee: HUAWEI TECHNOLOGIES CO., LTD., Shenzhen (CN)

(21) Appl. No.: 19/404,738

(22) Filed: Dec. 1, 2025

Related U.S. Application Data
(63) Continuation of application No. PCT/CN2024/095563, filed on May 27, 2024.

(30) Foreign Application Priority Data
Jun. 2, 2023 (CN) 202310654355.1

(51) Int. Cl. H04L 5/00; H04W 72/044; H04W 84/06

(52) U.S. Cl. CPC H04L 5/0051; H04L 5/0012; H04W 72/044; H04W 84/06

(57) ABSTRACT

A communication method and apparatus are provided, to reduce uplink signal interference caused by a PCI modulo conflict, thereby improving communication performance. The method includes: A second device sends first information, where the first information is used to obtain a virtual PCI of a first cell, and the virtual PCI is different from a PCI of the first cell; a first device receives the first information from the second device; the first device obtains the virtual PCI of the first cell based on the first information; the first device sends a first reference signal based on the virtual PCI; and the second device receives the first reference signal from the first device.

### CROSS-REFERENCE TO RELATED APPLICATIONS

This application is a continuation of International Application No. PCT/CN2024/095563, filed on May 27, 2024, which claims priority to Chinese Patent Application No. 202310654355.1, filed on Jun. 2, 2023. The disclosures of the aforementioned applications are hereby incorporated by reference in their entireties.

### TECHNICAL FIELD

This application relates to the communication field, and in particular, to a communication method and apparatus.

### BACKGROUND

With vigorous development of communication technologies, a future satellite communication network will be a large-scale constellation including tens of thousands of low earth orbit satellites, and provide satellite-to-ground communication services to user equipment (user equipment, UE). For example, a starlink (starlink) constellation is planned to launch 19 orbital shells with a total of 41927 satellites (or referred to as satellite base stations). Assuming that a coverage area of one satellite is planned as one or more cells and a physical cell identifier (physical cell identifier, PCI) is bound to the satellite, because a value range of the PCI is 0 to 1007, a maximum of 1008 cell PCIs with non-duplicate names are supported. Therefore, PCIs of tens of thousands of moving cells in the constellation may overlap.

In a communication process, a first device needs to determine, based on a PCI of a cell, a reference signal (for example, a demodulation reference signal (demodulation reference signal, DMRS)) needed for sending or receiving data. A PCI modulo conflict causes DMRSs of different cells to be same, resulting in communication interference. In a conventional terrestrial communication system, because a terrestrial base station is relatively stationary, a PCI of a cell may be bound to a terrestrial geographical location. In addition, through proper planning and allocation, adjacent cells (namely, first-order neighboring cells) or separated cells (namely, second-order neighboring cells) are prevented from using a same PCI, thereby preventing different cells from having a same DMRS, and reducing communication interference. However, in a non-terrestrial network (non-terrestrial network, NTN) communication system (for example, the foregoing satellite system), if communication interference is reduced by using the foregoing method for binding a PCI to a terrestrial geographical location, because movement of a satellite and another non-terrestrial flying object causes a frequent change in a coverage area of a cell, a modulo conflict may occur between PCIs of different cells, and a great burden is placed on PCI management in the communication system.

### SUMMARY

Embodiments of this application provide a communication method and apparatus, to reduce uplink signal interference caused by a PCI modulo conflict, thereby improving communication performance.

According to a first aspect, an embodiment of this application provides a communication method, applied to a first device. The first device herein may be a terminal device, or may be a processor, a module, a chip, a chip system, or the like that implements the method in a terminal device. The method includes: The first device receives first information from a second device; the first device obtains a virtual PCI of a first cell based on the first information, where the virtual PCI is different from a physical cell identifier PCI of the first cell; and the first device sends a first reference signal based on the virtual PCI.

In the method, the virtual PCI can be used to adjust the first reference signal sent by the first device or a manner of sending the first reference signal. Therefore, uplink signal interference caused by a modulo conflict between the PCI of the first cell and a PCI of a neighboring cell can be reduced, thereby improving communication performance.

In a possible design, the virtual PCI is a sequence group parameter, and the first device may determine a sequence group based on the sequence group parameter; and the first device sends the first reference signal based on the sequence group.

In such a design, the first device can determine the sequence group of the first reference signal by using the sequence group parameter, so that the first reference signal can be changed. This avoids a modulo conflict between the PCI of the first cell and a PCI of a neighboring cell, and reduces uplink signal interference, thereby improving communication performance.

In a possible design, the sequence group parameter, a preset value i of a modulo conflict, and the sequence group meet the following formula:

$$u = ( {f}_{g h} + {n}_{ID}^{R S} ) mod i$$

Herein, the mod function is a modulo function, u is the sequence group, f_{gh} is a group frequency hopping function of the sequence group, and

$${n}_{ID}^{R S}$$

is the sequence group parameter.

In such a design, a value of the sequence group parameter is not the PCI of the first cell. Therefore, the sequence group determined based on the sequence group parameter is not a sequence group determined in a conventional manner. In this way, sequence groups of the first cell and a neighboring cell are different, and reference signals of the first cell and the neighboring cell can be distinguished. This reduces uplink signal interference between the first cell and the neighboring cell, thereby improving communication accuracy.

In a possible design, the first information includes a value of the sequence group parameter; or the first information includes an offset value of the sequence group parameter relative to the PCI of the first cell.

In such a design, the sequence group parameter is more flexibly indicated, thereby improving applicability of a communication system in different scenarios.

In a possible design, the first information is used to trigger calculation of the sequence group parameter, the PCI of the first cell is a first PCI, and the first device determines the sequence group parameter based on the first PCI, the preset value i of the modulo conflict, and a preset parameter X. The sequence group parameter, the preset value i of the modulo conflict, and the first PCI meet the following formula:

$$Sequence group parameter = First PCI + [ First PCI / i ] + X$$

Herein, the [ ] function is a rounding function.

In such a design, a correspondence between the sequence group parameter and the first PCI is standardized, and accuracy of the sequence group parameter is improved, thereby improving accuracy of the communication method.

In a possible design, the first information further includes a validity period of the sequence group parameter; or the first device receives second information from the second device, where the second information includes a validity period of the sequence group parameter.

In such a design, the first device and the second device may reach a consensus on the validity period of the sequence group parameter, so that an uplink/downlink data demodulation error caused by data inconsistency can be avoided, thereby improving communication performance.

In a possible design, the virtual PCI is a first resource position parameter, and the first device updates a time-frequency resource position of a reference signal corresponding to the first cell from a first time-frequency resource position to a second time-frequency resource position based on the first resource position parameter, where the second time-frequency resource position is different from the first time-frequency resource position; and the first device sends the first reference signal at the second time-frequency resource position.

In such a design, the first device can determine, by using the first resource position parameter, a time domain resource position for sending the first reference signal, so that the resource position for sending the first reference signal can be changed. This avoids a modulo conflict between the PCI of the first cell and a PCI of a neighboring cell, and reduces uplink signal interference, thereby improving communication performance.

In a possible design, the PCI of the first cell is a first PCI, and the first PCI, a preset value i of a modulo conflict, and the first resource position parameter meet the following formula:

First resource position parameter-[First PCI/i]+1

Herein, the [ ] function is a rounding function.

In such a design, a correspondence between the first resource position parameter and the first PCI is standardized, and accuracy of the first resource position parameter is improved, thereby improving accuracy of the communication method.

In a possible design, the first device determines, based on the first resource position parameter, that a resource configuration type used by the first cell is a first resource configuration type, where the first resource configuration type is any one of N resource configuration types, N is a positive integer, and the N resource configuration types have different frequency domain resource density and/or time domain offset values; and the first device determines the second time-frequency resource position based on the first resource configuration type.

In such a design, the frequency domain density of the N resource configuration types can be adjusted, so that an available second time-frequency resource position is allocated to the first cell by using an adjusted resource configuration type. This avoids a modulo conflict between the PCI of the first cell and a PCI of a neighboring cell, thereby improving communication performance.

In a possible design, the first device determines a resource configuration rule, where the resource configuration rule includes a correspondence between the N resource configuration types and N resource position parameters; and the first device determines, based on the first resource position parameter and the resource configuration rule, that the resource configuration type used by the first cell is the first resource configuration type.

In such a design, the first resource configuration type is determined based on a fixed rule, and a manner of determining the first resource configuration type is standardized, so that the first device and the second device can separately obtain an accurate resource configuration type through calculation, thereby reducing signaling overheads.

In a possible design, the first information includes the resource configuration rule; or the first device receives the resource configuration rule from the second device.

In a possible design, frequency domain resource density of the first resource configuration type is less than or equal to ½, and a time domain offset value of the first resource configuration type is any integer from 1 to 13.

In a possible design, the first device receives third information from the second device, where the third information includes M PCIs corresponding to M second cells that have a modulo conflict with the first cell and whose time-frequency resource positions do not need to be updated; and the first device updates the time-frequency resource position of the first cell from the second time-frequency resource position to a third time-frequency resource position based on the M PCIs and the second time-frequency resource position.

In such a design, the first device may recursively shift the time-frequency resource position of the first cell forward or backward, thereby saving time-frequency resources.

In a possible design, the first device determines a second resource position parameter based on the first resource position parameter and the M PCIs; and the first device determines the third time-frequency resource position based on the second resource position parameter.

When M₁ PCIs in the M PCIs are less than the PCI of the first cell, M₁ is a positive integer, and M₁≤M, M₁, the first resource position parameter, and the second resource position parameter meet the following formula:

Second resource position parameter=First resource position parameter—M₁

In such a design, a manner of recursively shifting the time-frequency resource position of the first cell forward or backward is standardized, so that time-frequency resources are more properly used.

In a possible design, the first information is a first system message, and before receiving the first information from the second device, the first device may further receive a second system message from the second device, where the second system message indicates scheduling information needed for receiving the first system message; or the first device receives downlink control information DCI from the second device, where the DCI indicates scheduling information needed for receiving the first system message.

In such a design, the scheduling information may be transferred between the first device and the second device by using the second system message or the DCI, so that the first device can receive and decode the first system message as required, thereby saving computing resources of the first device.

According to a second aspect, an embodiment of this application provides a communication method, applied to a second device. The second device herein may be a network device (a base station, a satellite, or the like), or may be a processor, a module, a chip, or a chip system that implements the method in a network device. The second device may provide a service to a first device in a coverage area of the second device. The method includes: The second device sends first information, where the first information is used to obtain a virtual

PCI of a first cell, and the virtual PCI is different from a PCI of the first cell; and the second device receives a first reference signal from the first device, where the first reference signal is sent based on the virtual PCI.

In a possible design, the second device determines that there is a modulo conflict between the physical cell identifier PCI of the first cell and a PCI of a second cell, where the second cell is a neighboring cell of the first cell.

In such a design, the second device performs the communication method only when determining that there is a modulo conflict between the first cell and the second cell serving as the neighboring cell of the first cell. This reduces unnecessary signaling overheads, and avoids a waste of time-frequency resources.

In a possible design, the virtual PCI is a sequence group parameter, the first reference signal is determined based on a sequence group, and the sequence group is determined based on the sequence group parameter.

In a possible design, the sequence group parameter, a preset value i of the modulo conflict, and the sequence group meet the following formula:

$$u = ( {f}_{g h} + {n}_{ID}^{R S} ) mod i$$

Herein, the mod function is a modulo function, u is the sequence group, f_{gh} is a group frequency hopping function of the sequence group, and

$${n}_{ID}^{R S}$$

is the sequence group parameter.

In a possible design, the first information includes a value of the sequence group parameter; or the first information includes an offset value of the sequence group parameter relative to the PCI of the first cell.

In a possible design, the PCI of the first cell is a first PCI, the PCI of the second cell is a second PCI, a PCI of a third cell is a third PCI, and the preset value i of the modulo conflict indicates a quantity of reference signal combinations.

When the modulo conflict between the PCI of the first cell and the PCI of the second cell is a modulo i conflict, the second device determines that the first PCI, the second PCI, the preset value i of the modulo conflict, and the sequence group parameter meet the following formula:

$$( Sequence group parameter mod i ) \neq ( First PCI mod i ) and / or ( Sequence group parameter mod i ) \neq ( Second PCI mod i )$$

When the neighboring cell of the first cell further includes the third cell, the second device determines that the sequence group parameter, the preset value i of the modulo conflict, and the third PCI meet the following formula:

$$( Sequence group parameter mod i ) \neq ( Third PCI mod i )$$

In a possible design, the second device determines the sequence group parameter based on the first PCI, the preset value i of the modulo conflict, and a preset parameter X.

The sequence group parameter, the preset value i of the modulo conflict, and the first PCI meet the following formula:

$$Sequence group parameter = First PCI + [ First PCI / i ] + X$$

Herein, the [ ] function is a rounding function.

In a possible design, the first information further includes a validity period of the first PCI; or the second device sends second information, where the second information includes a validity period of the sequence group parameter.

In a possible design, the neighboring cell of the first cell further includes a fourth cell, and the second device sends the sequence group parameter to a third device, where the third device is a management device of the fourth cell.

In such a design, the second device can send the sequence group parameter of the first cell to the management device of the fourth cell, so that the third device can avoid a modulo conflict between the fourth cell and a neighboring cell, and can further avoid signal interference caused by the modulo conflict.

In a possible design, the virtual PCI is a first resource position parameter, and the second device updates a time-frequency resource position of a reference signal corresponding to the first cell from a first time-frequency resource position to a second time-frequency resource position based on the first resource position parameter, where the second time-frequency resource position is different from the first time-frequency resource position; and the second device receives the first reference signal from the first device at the second time-frequency resource position.

In a possible design, the PCI of the first cell is a first PCI, and the first PCI, a preset value i of a modulo conflict, and the first resource position parameter meet the following formula:

$$First resource position parameter = [ First PCI / i ] + 1$$

Herein, the [ ] function is a rounding function.

In a possible design, the second device determines, based on the first resource position parameter, that a resource configuration type used by the first cell is a first resource configuration type, where the first resource configuration type is any one of N resource configuration types, N is a positive integer, and the N resource configuration types have different frequency domain resource density and/or time domain offset values; and the second device determines the second time-frequency resource position based on the first resource configuration type.

In a possible design, the second device determines a resource configuration rule, where the resource configuration rule includes a correspondence between the N resource configuration types and N resource position parameters; and the second device determines, based on the first resource position parameter and the resource configuration rule, that the resource configuration type used by the first cell is the first resource configuration type.

In a possible design, the first information includes the resource configuration rule; or the second device sends the resource configuration rule.

In a possible design, frequency domain resource density of the first resource configuration type is less than or equal to ½, and a time domain offset value of the first resource configuration type is any integer from 1 to 13.

In a possible design, the second device sends third information, where the third information includes M PCIs corresponding to M second cells that have a modulo conflict with the first cell and whose time-frequency resource positions do not need to be updated; and the second device updates the time-frequency resource position of the first cell from the second time-frequency resource position to a third time-frequency resource position based on the M PCIs and the second time-frequency resource position.

In a possible design, the second device determines a second resource position parameter based on the first resource position parameter and the M PCIs; and the second device determines the third time-frequency resource position based on the second resource position parameter.

When M₁ PCIs in the M PCIs are less than the PCI of the first cell, M₁ is a positive integer, and MISM, M₁, the first resource position parameter, and the second resource position parameter meet the following formula:

Second resource position parameter=First resource position parameter—M₁

In a possible design, the first information is a first system message, and before sending the first information, the second device sends a second system message, where the second system message indicates scheduling information needed for receiving the first system message; or the second device sends downlink control information DCI, where the DCI indicates scheduling information needed for receiving the first system message.

In a possible design, the second device manages a plurality of cells, and the plurality of cells include the first cell and do not include the second cell that has a modulo conflict with the first cell; and when a topology of the plurality of cells is a regular hexagon, a PCI of each of the plurality of cells is any one of seven values; or when a topology of the plurality of cells is a rectangle, a PCI of each of the plurality of cells is any one of nine values.

In such a design, the second device can properly reuse a PCI between the plurality of cells, to minimize a quantity of PCI resources occupied by the cells managed by the second device, thereby reducing a PCI modulo conflict caused by movement of a satellite and another non-terrestrial flying object, and improving communication performance.

According to a third aspect, an embodiment of this application provides a communication apparatus, including modules configured to perform the steps in the first aspect or the second aspect. Optionally, the communication apparatus includes a communication module and a processing module. The communication module is configured to receive and send data. The processing module is configured to perform, based on the communication module, the method provided in the first aspect or the second aspect. For example, the communication apparatus may be used in the foregoing first device or second device.

According to a fourth aspect, an embodiment of this application provides a communication device, including a communication interface and a processor. The communication interface is configured to receive and send data. The processor is configured to read program instructions and data, to implement the method provided in the first aspect or the second aspect. Optionally, the communication device further includes a memory, configured to store program instructions and data. The memory may be coupled to the processor. For example, the communication device may be the foregoing first device or second device.

According to a fifth aspect, an embodiment of this application provides a communication device, including at least one processing element and at least one storage element. The at least one storage element is configured to store a program and data. The at least one processing element is configured to perform the method provided in the first aspect or the second aspect of this application. For example, the communication device may be the foregoing first device or second device.

According to a sixth aspect, an embodiment of this application further provides a computer program. When the computer program is run on a computer, the computer is enabled to perform the method provided in the first aspect or the second aspect. Optionally, the computer may be the foregoing first device or second device, or the foregoing communication apparatus or communication device.

According to a seventh aspect, this application provides a communication system, including a first device configured to implement the method provided in the first aspect and a second device configured to implement the method provided in the second aspect.

Optionally, the communication system may include the communication apparatus shown in the third aspect.

Optionally, the communication system may further include the communication device shown in the fourth aspect.

According to an eighth aspect, an embodiment of this application further provides a computer-readable storage medium. The computer-readable storage medium stores a computer program. When the computer program is executed by a computer, the computer is enabled to perform the method provided in the first aspect or the second aspect. Optionally, the computer may be the foregoing first device or second device, or the foregoing communication apparatus or communication device.

According to a ninth aspect, an embodiment of this application further provides a chip. The chip is configured to read a computer program stored in a memory, to perform the method provided in the first aspect or the second aspect. Optionally, the chip may include a processor and the memory. The processor is coupled to the memory, and is configured to read the computer program stored in the memory, to implement the method provided in the first aspect.

According to a tenth aspect, an embodiment of this application further provides a chip system. The chip system includes a processor, configured to support a computer apparatus in implementing the method provided in the first aspect or the second aspect. In a possible design, the chip system further includes a memory, and the memory is configured to store a program and data that are necessary for the computer apparatus. The memory may be coupled to the processor. The chip system may include a chip, or may include a chip and another discrete component.

For technical effects that can be achieved in any one of the second aspect to the tenth aspect, refer to the descriptions of the technical effects that can be achieved in any possible design of the first aspect. No repeated descriptions are provided.

### BRIEF DESCRIPTION OF DRAWINGS

FIG. 1 is a diagram of an architecture of a communication system according to an embodiment of this application;

FIG. 2 is a diagram of an architecture of a non-terrestrial network communication system according to an embodiment of this application;

FIG. 3 is a diagram of an architecture of a 5G satellite communication system according to an embodiment of this application;

FIG. 4 is a schematic flowchart of a communication method according to an embodiment of this application;

FIG. 5 is an example diagram of another communication method according to an embodiment of this application;

FIG. 6 is an example diagram of another communication method according to an embodiment of this application;

FIG. 7 is an example diagram of a resource configuration type according to an embodiment of this application;

FIG. 8(1) to FIG. 8(4) are an example diagram of a time-frequency resource position according to an embodiment of this application;

FIG. 9 is an example diagram of a topology of a satellite cell according to an embodiment of this application;

FIG. 10 is a diagram of a structure of a communication apparatus according to an embodiment of this application; and

FIG. 11 is a diagram of a structure of a communication device according to an embodiment of this application.

### DESCRIPTION OF EMBODIMENTS

To make the objectives, technical solutions, and beneficial effects of this application clearer, the following further describes this application in detail with reference to accompanying drawings and embodiments. It should be understood that the specific embodiments described herein are merely used to explain this application but are not intended to limit this application.

In descriptions of embodiments of this application, the term “and/or” describes an association relationship between associated objects and indicates that three relationships may exist. For example, A and/or B may indicate the following three cases: Only A exists, both A and B exist, and only B exists. In this application, “a plurality of” means two or more. In addition, it should be understood that in the descriptions of this application, terms such as “first” and “second” are merely used for differentiation and description, but should not be understood as an indication or implication of relative importance, or should not be understood as an indication or implication of a sequence.

The following describes in detail embodiments of this application with reference to accompanying drawings.

The communication method provided in embodiments of this application may be applied to a 4th generation (4th generation, 4G) communication system (for example, long term evolution (long term evolution, LTE)), may be applied to a 5th generation (5th generation, 5G) communication system (for example, 5G new radio (new radio, NR)), may be applied to various future evolved communication systems (for example, a 6th generation (6th generation, 6G) communication system), or may be applied to a space-air-sea-ground integrated communication system. The method provided in embodiments of this application may be applied to a terrestrial network communication system, or may be applied to a non-terrestrial network (non-terrestrial network, NTN) communication system. For example, the NTN communication system may be a satellite communication system.

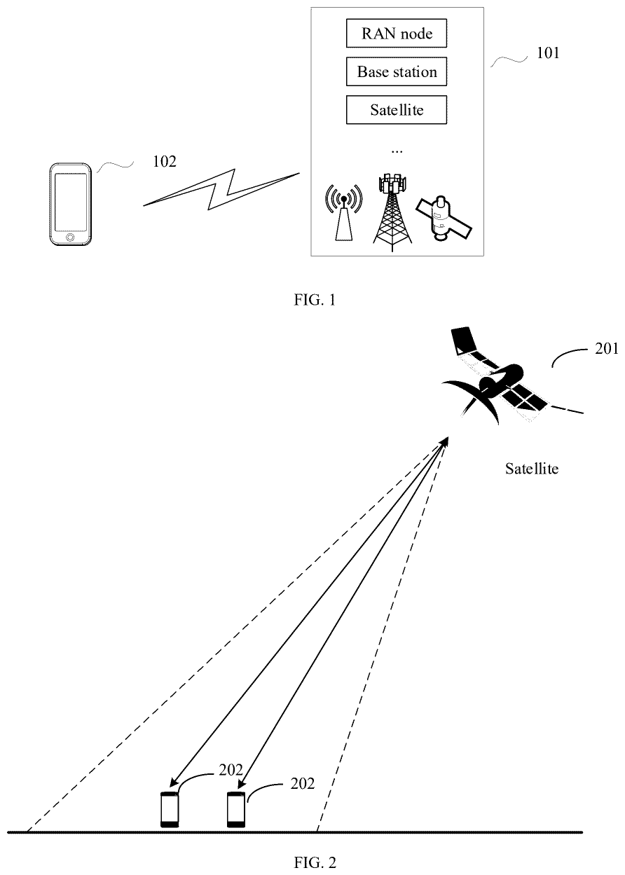

FIG. 1 shows an architecture of a communication system to which an embodiment of this application is applicable. As shown in FIG. 1, a communication system 100 includes a second device 101 and a first device 102.

Possible implementation forms and functions of the second device 101 and the first device 102 are first described by using an example.

The second device 101 provides a service to the first device 102 in a coverage area. For example, as shown in FIG. 1, the second device 101 provides wireless access to one or more first devices 102 in the coverage area of the second device 101.

The second device 101 may be a node in a radio access network (radio access network, RAN), and may also be referred to as a base station, or may be referred to as a RAN node (or device). When the second device 101 is a base station, an example of the base station is a next generation NodeB (next generation NodeB, gNB), a next generation evolved NodeB (next generation evolved NodeB, Ng-eNB), a transmission reception point (transmission reception point, TRP), an evolved NodeB (evolved NodeB, eNB), a radio network controller (radio network controller, RNC), a NodeB (NodeB, NB), a base station controller (base station controller, BSC), a base transceiver station (base transceiver station, BTS), a home base station (for example, a home evolved NodeB or a home NodeB, HNB), a baseband unit (baseband unit, BBU), or a wireless fidelity (wireless fidelity, Wi-Fi) access point (access point, AP).

The second device 101 may alternatively be a module or unit that completes some functions of a base station, for example, may be a central unit (central unit, CU), or may be a distributed unit (distributed unit, DU). The CU herein completes functions of a radio resource control protocol and a packet data convergence protocol (packet data convergence protocol, PDCP) of the base station, and may further complete a function of a service data adaptation protocol (service data adaptation protocol, SDAP). The DU completes functions of a radio link control layer and a medium access control (medium access control, MAC) layer of the base station, and may further complete some or all of functions of a physical layer. For specific descriptions of the foregoing protocol layers, refer to related technical specifications of a 3rd generation partnership project (3rd generation partnership project, 3GPP).

The second device 101 may alternatively be a satellite, and the satellite may also be referred to as a high-altitude platform, a high-altitude aircraft, or a satellite base station. The second device 101 may alternatively be another device that has a function of the second device. For example, the second device 101 may alternatively be a device that performs the function of the second device in device-to-device (device-to-device, D2D) communication, an internet of vehicles, or machine-to-machine (machine-to-machine, M2M) communication. The second device 101 may alternatively be any possible second device in a future communication system. In embodiments of this application, the function of the second device 101 may alternatively be performed by a module (for example, a chip) in the second device, or may be performed by a control subsystem including the function of the second device. The control subsystem including the function of the second device herein may be a control center in the foregoing application scenarios such as smart grid, industrial control, intelligent transportation, and smart city.

The first device 102 is also referred to as user equipment (user equipment, UE), a mobile station (mobile station, MS), a mobile terminal (mobile terminal, MT), or the like, and is a device that provides voice and/or data connectivity to users. For example, the first device 102 includes a handheld device or a vehicle-mounted device having a wireless connection function. Currently, the first device 102 may be a mobile phone (mobile phone), a tablet computer, a notebook computer, a palmtop computer, a mobile internet device (mobile internet device, MID), a wearable device (for example, a smart watch, a smart band, or a pedometer), a vehicle-mounted device (for example, a vehicle, a bicycle, an electric vehicle, an airplane, a ship, a train, or a high-speed train), a virtual reality (virtual reality, VR) device, an augmented reality (augmented reality, AR) device, a wireless terminal in industrial control (industrial control), a smart household device (for example, a refrigerator, a television, an air conditioner, or a meter), a smart robot, a workshop device, a wireless terminal in self-driving (self-driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), a flight device (for example, a smart robot, a hot air balloon, an uncrewed aerial vehicle, or an airplane), or the like.

The first device 102 may alternatively be another device having a function of the terminal device. For example, the first device 102 may alternatively be a device that performs the function of the first device in device-to-device (device-to-device, D2D) communication, an internet of vehicles, or machine-to-machine (machine-to-machine, M2M) communication. Particularly, when communication is performed between second devices, a second device that performs the function of the first device may also be considered as the first device. The method provided in embodiments of this application may be performed by the first device, or may be performed by a component (for example, a processor, a chip, or a chip system) in the first device.

Based on the descriptions of the architecture of the communication system shown in FIG. 1, the method provided in embodiments of this application is also applicable to an NTN communication system. In embodiments of this application, an example in which the NTN communication system is a satellite communication system is used.

As shown in FIG. 2, the NTN communication system may include a satellite 201 and a terminal device 202. For explanations of the terminal device 202, refer to the foregoing related descriptions of the terminal device 102. The satellite 201 may also be referred to as a high-altitude platform, a high-altitude aircraft, or a satellite base station. When the NTN communication system is associated with a terrestrial network communication system, the satellite 201 may be considered as one or more base stations in an architecture of the terrestrial network communication system. The satellite 201 provides a communication service to the terminal device 202, and the satellite 201 may be further connected to a core network device. For a structure and a function of the satellite 201, refer to the foregoing descriptions of the second device 101. For a communication manner between the satellite 201 and the terminal device 202, refer to the descriptions in FIG. 1. Details are not described herein.

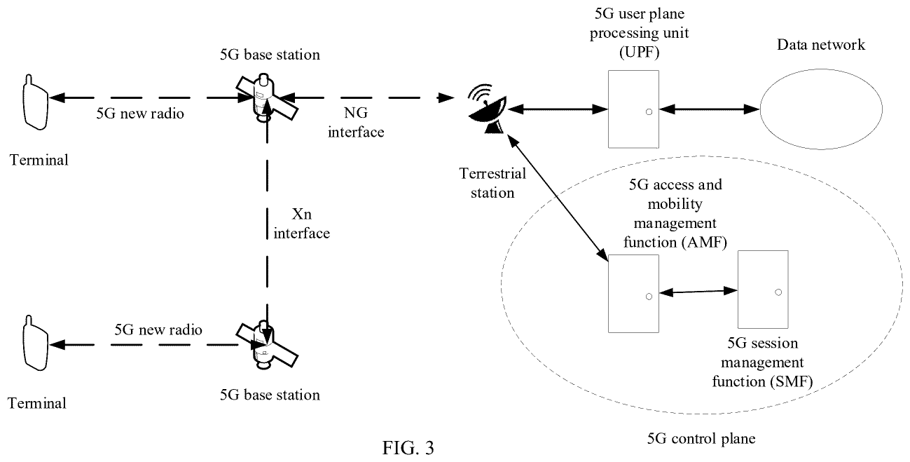

A 5G technology integrated with satellite communication is used as an example. An architecture of a 5G satellite communication system is shown in FIG. 3. A terrestrial terminal device may access a network through 5G new radio. A 5G base station is deployed on a satellite, and is connected to a terrestrial core network through a radio link. In addition, there is a radio link between satellites, to complete signaling exchange and user data transmission between base stations. Devices and interfaces in FIG. 3 are described as follows:

A 5G core network provides services such as user access control, mobility management, session management, user security authentication, and charging. The 5G core network includes a plurality of functional units, and may be divided into a control plane functional entity and a data plane functional entity. An access and mobility management unit (AMF) is responsible for user access management, security authentication, and mobility management. A user plane unit (UPF) is responsible for management of user-plane data transmission, traffic statistics collection, lawful interception, and other functions.

A terrestrial station is responsible for forwarding signaling and service data between a satellite base station and the 5G core network.

5G new radio is a radio link between a terminal and a base station.

An Xn interface is an interface between 5G base stations, and is mainly used for signaling exchange such as handover.

An NG interface is an interface between the 5G base station and the 5G core network, and is mainly used to exchange NAS or other signaling of the core network and service data of a user.

The terminal is a mobile device that supports 5G new radio, and may access a satellite network through an air interface and initiate services such as calls and internet access. For example, the terminal may be considered as the first device 102 included in the communication system 100 or the terminal device 202 in the NTN communication system.

The 5G base station provides a wireless access service, schedules radio resources for an access terminal, and provides a reliable wireless transmission protocol, a reliable data encryption protocol, and the like. For example, the 5G base station may be considered as the second device 101 included in the communication system 100, the satellite 201 in the NTN communication system, or an apparatus (for example, a chip system, where the apparatus may be installed in the second device) configured to implement a function of a network device.

To reduce a burden on PCI management in the NTN communication system, this application provides a method for implementing communication by binding a PCI to a non-terrestrial flying object (for example, a satellite). Satellite communication is used as an example. In such a method, as a satellite moves and a coverage area changes, different PCIs are used when a same location is covered by different satellites. When a scale of a constellation including a plurality of satellites increases, the foregoing PCI allocation manner may increase a probability that a PCI modulo conflict occurs between first-order neighboring cells in the constellation. Further, when a PCI modulo conflict occurs between the first-order neighboring cells, sequences of DMRSs determined by a first device for different cells between which a modulo conflict occurs in the first-order neighboring cells are the same, and time-frequency resource positions of the DMRSs are limited. Therefore, during communication of the first device in different cells, a same time-frequency resource is used to transmit a physical uplink shared channel (physical uplink shared channel, PUSCH), resulting in uplink signal interference in a communication process.

Embodiments of this application provide a communication method, to resolve a problem of uplink signal interference caused by a PCI modulo conflict. It may be understood that when the method provided in embodiments of this application is applied to the NTN communication system, an action performed by the second device may be applied to the satellite for execution. In addition, the second device may be a management device of a plurality of satellites, and the management device may be a device other than the plurality of satellites, or may be any one of the plurality of satellites.

The following describes in detail embodiments of this application with reference to accompanying drawings.

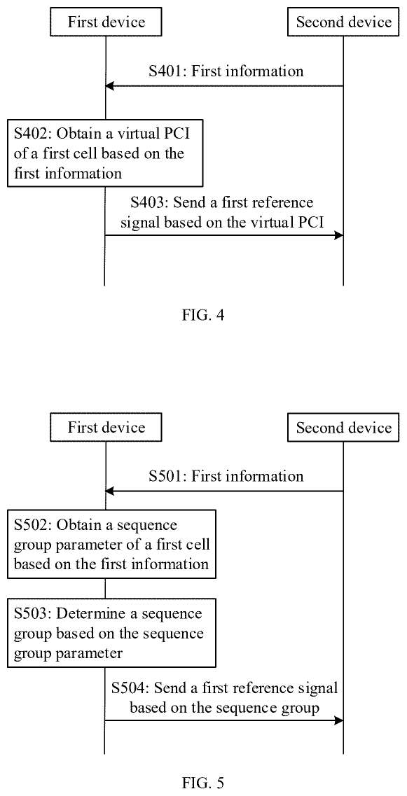

FIG. 4 is a schematic flowchart of a communication method according to an embodiment of this application. The method is applicable to any one of the communication systems shown in FIG. 1 to FIG. 3. With reference to FIG. 4, the following describes the method provided in embodiments of this application.

S401: A second device sends first information. Correspondingly, a first device receives the first information from the second device.

With reference to the communication systems shown in FIG. 1 to FIG. 3, the second device may be but is not limited to any one of the following: the second device 101 included in the communication system 100, the satellite 201 in the NTN communication system, or the 5G base station in the architecture of the 5G satellite communication system; and the first device may be but is not limited to any one of the following: the first device 102 included in the communication system 100, the terminal device 202 in the NTN communication system, or the terminal in the architecture of the 5G satellite communication system.

The first information is used by the first device to obtain a virtual PCI of a first cell. For example, the first information may include the virtual PCI of the first cell, or may further include information used to trigger calculation of the virtual PCI of the first cell. It should be understood that the first cell is any one of cells managed by the second device. In a communication process, the first device may access the first cell, and establish communication with the second device by using a PCI of the first cell.

Optionally, the first information is a first system message. It should be understood that system messages may be classified into a master information block (Master Information Block, MIB) and a system information block (System Information Block, SIB), and each system message includes a series of parameters related to a specific function. The MIB and a SIB 1 may be separately sent, and another SIB (for example, a SIB x) needs to be sent in a system information (system information, SI) window (that is, an SI message). Further, the first device receives one or more required SI messages by using scheduling information, and obtains a corresponding system message through decoding.

Optionally, the first device and the second device may preset a default validity period (for example, 3 hours) of the system message, and the first device may actively trigger updating of the system message after the validity period ends. For example, the first device may receive a new system message again 3 hours after receiving a system message, to complete updating of the system message.

Optionally, the first device may alternatively trigger updating of the system message after receiving instruction information indicating that there is a system message change. For example, before step S401 is performed, the first device may obtain, in the following two manners, scheduling information needed for receiving the first system message:

Manner 1: The second device sends a second system message, where the second system message indicates the scheduling information needed for receiving the first system message. Correspondingly, the first device receives the second system message from the second device. For example, the SIB 1 may be used as the second system message to notify the first device that there is a system message change (that is, the scheduling information is indicated). A specific method includes:

1. The second device configures a PCI_update (update) field in the SIB 1, and sets the field to “enable (enable)”. The SIB 1 may further indicate scheduling information of a SIB x corresponding to the first system message. Correspondingly, if the first device determines that a value of the PCI_update field is “enable”, it is determined that there is a system message change, and then the SIB x is received based on the scheduling information.

2. The second device increases a value of a system information value tag (system Info Value Tag) field in the SIB 1 by 1. The SIB 1 may further indicate scheduling information of a SIB x corresponding to the first system message. Correspondingly, if the first device determines that the value of the field is increased by 1 compared with a previous value, it is determined that there is a system message change, and then the SIB x is received based on the scheduling information.

Manner 2: The second device sends downlink control information (Downlink Control Information, DCI), where the DCI indicates the scheduling information needed for receiving the first system message. Correspondingly, the first device receives the DCI from the second device. For example, the DCI may be used to notify the first device that there is a system message change (that is, the scheduling information is indicated). A specific method includes:

1. The second device configures a flag (flag) field in the DCI. The field indicates updating of the system message, and the DCI may further indicate scheduling information of a SIB x corresponding to the first system message. Correspondingly, if the first device determines that the DCI includes the flag field, it is determined that there is a system message change, and then the SIB x is received based on the scheduling information.

2. The second device delivers paging DCI, so that the first device receives a paging (paging) message corresponding to the paging DCI. The second device may set a system information modification (system Info Modification) field in the paging message to “true”. The paging DCI may further include scheduling information of a SIB x corresponding to the first system message. Correspondingly, if the first device determines that the system Info Modification field in the paging message is “true”, it is determined that there is a system message change, and then the SIB x is received based on the scheduling information.

In a possible example, if the first device receives, at a moment, a paging message whose system Info Modification field is true, triggering of updating of the system message is determined. Correspondingly, the first device receives and decodes the SIB 1 at a system message change point closest to the current paging message. The SIB 1 may include scheduling information of a SIB x corresponding to the first system message. Further, the first device may receive the SIB x by using the scheduling information in the SIB 1, that is, the first device receives the first system message based on the scheduling information. On the contrary, if the first device does not receive information for triggering updating of the system message, the first device does not need to receive the SIB x.

In such a design, the scheduling information may be transferred between the first device and the second device by using the second system message or the DCI, so that the first device can receive and decode the first system message (namely, necessary information in the SIB x) as required, and does not need to receive or decode another SIB x synchronously sent with the first system message, thereby saving computing resources of the first device.

In a possible design before step S401 is performed, the second device may further determine that there is a modulo conflict between the PCI of the first cell and a PCI of a second cell. The second cell is a neighboring cell of the first cell, and the modulo conflict includes but is not limited to any one of a modulo 3 conflict, a modulo 30 conflict, or a modulo 60 conflict. A type of the modulo conflict is related to a quantity of reference signal combinations. In this application, a preset value i of the modulo conflict may be used for representation. A value of i includes but is not limited to 3, 30, and 60. It should be understood that when determining that there is a modulo conflict, the second device performs an action shown in step S401, and vice versa.

For example, the first device is a terminal and the second device is a satellite. The satellite may obtain a neighboring relation table (neighboring relation table, NRT), and determine a neighboring cell set (including the second cell) of the first cell based on the NRT. For a manner of obtaining the NRT by the satellite, refer to a conventional technical manner. This is not limited in this application. For example, in an initial network configuration phase, the satellite independently adds a neighboring relation. For another example, in a subsequent cell handover phase, the satellite checks and adds a missing neighboring cell based on cell information reported by the terminal. The satellite may further determine whether there is a modulo conflict between the PCI of the first cell and a PCI of any cell in the neighboring cell set. For example, when the PCI of the first cell is 31 and the PCI of the second cell is 61, there is a modulo 30 conflict between the first cell and the second cell.

S402: The first device obtains the virtual PCI of the first cell based on the first information, where the virtual PCI is different from the PCI of the first cell.

For example, when the first information includes the virtual PCI, the first device directly obtains the virtual PCI by using the first information. For example, the second device may broadcast the virtual PCI to the first device by using cell-level RRC signaling. When the first information is used to trigger calculation of the virtual PCI, the first device obtains the virtual PCI through calculation.

Optionally, the virtual PCI may be a sequence group parameter or a resource position parameter. The sequence group parameter is used to determine a sequence group of a reference signal, and the sequence group is used to determine a value of the reference signal. The resource position parameter is used to determine a time-frequency resource position for sending a reference signal.

S403: The first device sends a first reference signal based on the virtual PCI. Correspondingly, the second device receives the first reference signal from the first device.

It should be understood that when the virtual PCI is a sequence group parameter, the first device can adjust a sequence group of a reference signal, so as to adjust the reference signal; or when the virtual PCI is a resource position parameter, the first device can adjust a time-frequency resource position of a reference signal.

The first reference signal may be a DMRS or a sounding reference signal (sounding reference signal, SRS). The first reference signal is used by the second device to decode uplink data from the first device. The uplink data includes a message 3 (Message 3, Msg3) or an uplink PUSCH.

Optionally, the second device may further determine the virtual PCI of the first cell by using a method the same as that in step S402, and update a value of the reference signal based on the virtual PCI, or update a time-frequency resource position for sending the reference signal.

In the communication method shown in step S401 to step S403, the virtual PCI can be used to adjust the first reference signal sent by the first device or a manner of sending the first reference signal. Therefore, uplink signal interference caused by a modulo conflict between the PCI of the first cell and a PCI of a neighboring cell can be reduced, thereby improving communication performance.

With reference to FIG. 5, the following describes, by using an example in which a virtual PCI is a sequence group parameter, the communication method provided in embodiments of this application. FIG. 5 is a schematic flowchart of a communication method according to an embodiment of this application. The method is a possible embodiment of the communication method in step S401 to step S403. In this embodiment of this application, it is assumed that a first cell is any one of cells managed by a second device, a PCI of the first cell is a first PCI, a second cell and a third cell are neighboring cells of the first cell, a PCI of the second cell is a second PCI, and a PCI of the third cell is a third PCI.

S501: The second device sends first information. Correspondingly, a first device receives the first information from the second device. The first information is used by the second device to directly send a sequence group parameter to the first device, and the sequence group parameter may be sent by using an SI window. Alternatively, the first information is used by the second device to send an instruction for triggering calculation of a sequence group parameter to the first device.

Optionally, a value range of the sequence group parameter may be defined as [1, 30]. In this way, the sequence group parameter occupies only 5 bits (bit). This can reduce bit overheads.

Optionally, the sequence group parameter has a validity period, and the validity period may be sent by using the SI window. The first information further includes the validity period of the sequence group parameter; or the first device may further receive second information from the second device, where the second information includes the validity period of the sequence group parameter.

In a possible design, the sequence group parameter is directly specified by the second device, and is notified by the second device to the first device by using the first information.

Optionally, when the second device determines the sequence group parameter, the following selection principles need to be met:

Principle 1: When a modulo conflict between the PCI of the first cell and the PCI of the second cell is a modulo i conflict, the second device determines that the first PCI, the second PCI, and the sequence group parameter meet the following formula:

$$( Sequence group parameter mod i ) \neq ( First PCI mod i ) and / or ( Sequence group parameter mod i ) \neq ( Second PCI mod i )$$

Principle 2: When the neighboring cell of the first cell further includes the third cell, the second device determines that the sequence group parameter and the third PCI meet the following formula:

$$( Sequence group parameter mod i ) \neq ( Third PCI mod i )$$

It should be understood that in the formula in this application, the mod function is a modulo function.

For example, when the modulo conflict is a modulo 30 conflict, a value of i is 30. The neighboring cell of the first cell includes at least one second cell that has a modulo 30 conflict with the first cell and at least one third cell. It is assumed that the PCI of the first cell is 1, a PCI of one second cell is 31, and PCIs of two third cells are respectively 2 and 11, that is, a modulo 30 remainder of the neighboring cell of the first cell includes 1, 2, and 11. Based on the foregoing principles, the second device may determine that the sequence group parameter is any integer other than {1, 2, 11} in an interval [1, 30]. For example, the sequence group parameter is 10.

Optionally, the first information includes a value of the sequence group parameter; or the first information includes an offset value of the sequence group parameter relative to the PCI of the first cell.

Optionally, when the first information includes the offset value of the sequence group parameter relative to the PCI of the first cell, the offset value occupies 5 bits. A manner of indicating the offset value includes but is not limited to the following manner a, manner b, and manner c:

Manner a: A first bit indicates whether an offset direction is a positive offset (0) or a negative offset (1), and the last 4 bits indicate a value of an offset. For example, if the modulo conflict is a modulo 30 conflict and a modulo 30 remainder of the PCI of the current cell is 15, a maximum offset of the sequence group parameter relative to the PCI of the current cell is 15 (1111). In this case, a maximum of 4 bits are required to indicate the offset, and only 1 bit is required to indicate the offset direction. A total of 5 bits are required. It should be understood that the offset value in the manner a includes the offset direction and the offset value.

For example, when the first PCI is 31 and the sequence group parameter is 14, the second device determines that the sequence group parameter is positively offset by 13 based on the modulo 30 remainder of the first PCI. In this case, the offset value of the sequence group parameter is 01101.

Manner b: When a modulo 30 remainder of the PCI of the current cell is less than or equal to 15, a default offset direction is a positive offset (or a negative offset). When a modulo 30 remainder of the PCI of the current cell is greater than 15, a default offset direction is a negative offset (or a positive offset). All of the 5 bits indicate an offset of the sequence group parameter relative to the PCI of the current cell.

For example, when the first PCI is 31 (the modulo 30 remainder is 1) and the sequence group parameter is 14, the default offset direction is a positive offset (or a negative offset), and the second device determines that the offset value of the sequence group parameter is (13) 01101.

Manner c: When a modulo 30 remainder of the PCI of the current cell is less than or equal to an offset, a default offset direction is a positive offset (or a negative offset). When a modulo 30 remainder of the PCI of the current cell is greater than an offset, a default offset direction is a negative offset (or a positive offset). All of the 5 bits indicate the offset of the sequence group parameter relative to the PCI of the current cell.

For example, when the PCI of the current cell is 31, the modulo 30 remainder of the PCI of the current cell is 1. When the sequence group parameter of the current cell is 5, the offset is 4. Because 1<4, the second device may determine that the offset direction is a positive offset (or a negative offset), and the second device determines that the offset value of the sequence group parameter is 00100.

In another possible design, the sequence group parameter is separately calculated by the first device and the second device, and the second device transfers a calculation instruction by using the first information.

It should be understood that both the first device and the second device should obtain the sequence group parameter through calculation when the foregoing selection principles of the sequence group parameter are met.

Optionally, the second device obtains the sequence group parameter through calculation. A specific method may be: The second device determines the sequence group parameter based on the first PCI, a preset value i of a modulo conflict, and a preset parameter X. The sequence group parameter, the preset value i of the modulo conflict, and the first PCI meet the following formula:

$$Sequence group parameter = First PCI + [ First PCI / i ] + X$$

It should be understood that in the formula in this application, the [ ] function is a rounding function (or referred to as a Gaussian function).

For example, when the modulo conflict is a modulo 30 conflict, a value of i is 30, and the preset parameter X is 6. If the PCI of the first cell is 1, the second device may determine that the value of the sequence group parameter is 7. If the PCI of the first cell is 31, the second device may determine that the value of the sequence group parameter is 38. If the PCI of the first cell is 61, the second device may determine that the value of the sequence group parameter is 69.

In a possible design, the neighboring cell of the first cell further includes a fourth cell, and the second device may further send the sequence group parameter to a third device, where the third device is a management device of the fourth cell.

Optionally, the third device may determine a PCI of the fourth cell based on the sequence group parameter of the first cell; or the third device may determine a sequence group parameter of the fourth cell based on the sequence group parameter.

In such a design, the third device can avoid a modulo conflict between the fourth cell and a neighboring cell, and avoid signal interference caused by the modulo conflict.

It should be understood that the actions in step S401 may include some or all of the actions in step S501. This is not limited in this application. Before performing step S501, the second device may further perform the action of determining that there is a modulo conflict between the PCI of the first cell and the PCI of the second cell in step S401.

S502: The first device obtains the sequence group parameter of the first cell based on the first information, where the sequence group parameter is different from the PCI of the first cell.

In a possible design, the first device may obtain the sequence group parameter in any one of the following manners:

Manner A: When the first information includes the sequence group parameter, the first device directly receives the sequence group parameter by using the first information.

Manner B: When the first information is used to trigger calculation of the sequence group parameter, the first device obtains the sequence group parameter through calculation. A specific manner may be B1 or B2.

B1: The first device determines the sequence group parameter based on the offset value of the sequence group parameter and the first PCI.

Optionally, the offset value of the sequence group parameter occupies 5 bits.

Based on the indication manner of the offset value in step S501, a specific manner of determining the sequence group parameter in B1 includes but is not limited to the following manner a, manner b, and manner c:

Manner a: It is known that the offset value of the sequence group parameter occupies 5 bits. A first bit indicates whether an offset direction is a positive offset (0) or a negative offset (1), and the last 4 bits indicate a value of an offset. For example, if the modulo conflict is a modulo 30 conflict and a modulo 30 remainder of the PCI of the current cell is 15, a maximum offset of the sequence group parameter relative to the PCI of the current cell is 15 (1111). In this case, a maximum of 4 bits are required to indicate the offset, and only 1 bit is required to indicate the offset direction. A total of 5 bits are required.

For example, when the offset value of the sequence group parameter is 01101, the first device determines that the sequence group parameter is positively offset by 13 based on the modulo 30 remainder of the first PCI. If the first PCI is 31, the first device determines that the sequence group parameter is 14.

Manner b: It is known that all of the 5 bits indicate an offset of the sequence group parameter relative to the PCI of the current cell. When a modulo 30 remainder of the PCI of the current cell is less than or equal to 15, a default offset direction is a positive offset (or a negative offset). When a modulo 30 remainder of the PCI of the current cell is greater than 15, a default offset direction is a negative offset (or a positive offset).

For example, when the offset value of the sequence group parameter is 01101 and the first PCI is 31, because the modulo 30 remainder of 31 is less than 15, the first device determines that the default offset direction is a positive offset (or a negative offset) 13. If the default offset direction is a positive offset, the first device determines that the sequence group parameter is 14.

Manner c: It is known that all of the 5 bits indicate an offset of the sequence group parameter relative to the PCI of the current cell. When a modulo 30 remainder of the PCI of the current cell is less than or equal to the offset, a default offset direction is a positive offset (or a negative offset). When a modulo 30 remainder of the PCI of the current cell is greater than the offset, a default offset direction is a negative offset (or a positive offset).

For example, when the offset value of the sequence group parameter is 00100 and the PCI of the current cell is 31, the first device may determine that the modulo 30 remainder of the PCI of the current cell is 1 and the offset is 4. Because 1<4, the first device may determine that the offset direction is a positive offset (or a negative offset), and the first device determines that the sequence group parameter is 5.

B2: The first device determines the sequence group parameter based on the first PCI, a preset value i of a modulo conflict, and a preset parameter X. Optionally, the sequence group parameter, the preset value i of the modulo conflict, and the first PCI meet the following formula:

$$Sequence group parameter = First PCI + [ First PCI / i ] + X$$

For example, when the modulo conflict is a modulo 30 conflict, a value of i is 30, and the preset parameter X is 6. If the PCI of the first cell is 1, the first device may determine that the value of the sequence group parameter is 7. If the PCI of the first cell is 31, the first device may determine that the value of the sequence group parameter is 38. If the PCI of the first cell is 61, the first device may determine that the value of the sequence group parameter is 69.

It should be understood that when the sequence group parameter is directly specified by the second device, the first device obtains the sequence group parameter in the manner A or the manner B1; or when the sequence group parameter is separately calculated by the first device and the second device, the first device obtains the sequence group parameter in the manner B2.

It should be understood that the actions in step S402 may include some or all of the actions in step S502. This is not limited in this application.

S503: The first device determines a sequence group based on the sequence group parameter.

In a conventional communication process, when there is a modulo conflict between the PCI of the first cell and the PCI of the second cell, values of sequence groups determined based on the PCI of the first cell and the PCI of the second cell are the same. Because a value of a reference signal is determined based on the sequence group, communication interference is generated between the first cell and the second cell. However, in the method shown in step S503, the sequence group of the first cell is determined based on the sequence group parameter, and is not determined based on the PCI of the first cell. Therefore, values of sequence groups of the first cell and the second cell are different, thereby avoiding signal interference.

Optionally, the sequence group parameter, the preset value i of the modulo conflict, and the sequence group meet the following formula:

$$u = ( {f}_{g h} + {n}_{ID}^{R S} ) mod i$$

Herein, the mod function is a modulo function, u is the sequence group, f_{gh} is a group frequency hopping function of the sequence group, and

$${n}_{ID}^{R S}$$

is the sequence group parameter.

S504: The first device sends a first reference signal based on the sequence group. Correspondingly, the second device receives the first reference signal from the first device.

For example, the first device determines the first reference signal based on the sequence group, and sends the first reference signal.

In the communication method shown in step S501 to step S504, the first device can determine the sequence group of the first reference signal by using the sequence group parameter, so that the first reference signal can be changed. This avoids a modulo conflict between the PCI of the first cell and a PCI of a neighboring cell, and reduces uplink signal interference, thereby improving communication performance.

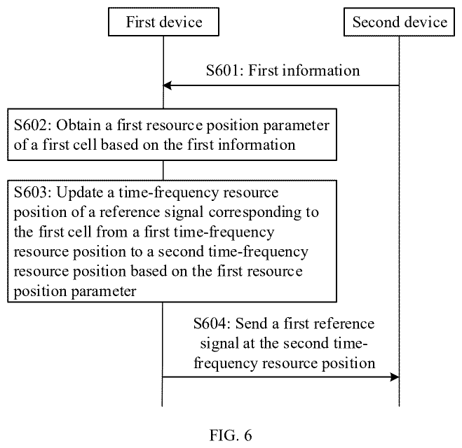

With reference to FIG. 6, the following describes, by using an example in which a virtual PCI is a resource position parameter, the communication method provided in embodiments of this application. FIG. 6 is a schematic flowchart of a communication method according to an embodiment of this application. The method is a possible embodiment of the communication method in step S401 to step S403. In this embodiment of this application, it is assumed that a first cell is any one of cells managed by a second device, a PCI of the first cell is a first PCI, a second cell is a neighboring cell of the first cell, a PCI of the second cell is a second PCI, and a preset value i of a modulo conflict indicates a quantity of reference signal combinations.

S601: The second device sends first information. Correspondingly, a first device receives the first information from the second device. The first information is used by the first device to obtain a first resource position parameter, and the first resource position parameter may be sent by using an SI window.

It should be understood that the actions in step S401 include some or all of the actions in step S601. This is not limited in this application. For example, before performing step S601, the second device may further perform the action of determining that there is a modulo conflict between the PCI of the first cell and the PCI of the second cell in step S401.

S602: The first device obtains the first resource position parameter of the first cell based on the first information, where the first resource position parameter is different from the PCI of the first cell. The first resource position parameter is used to determine a time-frequency resource position used when the first device sends a reference signal.

In a possible design, the first device and the second device may separately obtain the first resource position parameter through calculation, and the second device transfers a calculation instruction by using the first information.

Optionally, the first device may determine the first resource position parameter based on the first PCI and the preset value i of the modulo conflict. Optionally, the first PCI, the preset value i of the modulo conflict, and the first resource position parameter meet the following formula:

$$First resource position parameter = [ First PCI / i ] + 1$$

Optionally, based on the sequence group parameter determined in step S501 to step S504, the first device may determine the first resource position parameter based on the sequence group parameter and the preset value i of the modulo conflict. Optionally, the sequence group parameter, the preset value i of the modulo conflict, and the first resource position parameter meet the following formula:

$$First resource position parameter = [ Sequence group parameter / i ] + 1$$

Correspondingly, the second device may determine the first resource position parameter in a manner the same as that of the first device. Details are not described herein.

It should be understood that the actions in step S402 may include some or all of the actions in step S602. This is not limited in this application.

S603: The first device may update a time-frequency resource position of a reference signal corresponding to the first cell from a first time-frequency resource position to a second time-frequency resource position based on the first resource position parameter, where the second time-frequency resource position is different from the first time-frequency resource position.

It should be understood that before the first device receives the first information, that is, before step S601 is performed, the first device sends a first reference signal at the first time-frequency resource position.

In a conventional communication process, when there is a modulo conflict between the PCI of the first cell and the PCI of the second cell, sequence groups of reference signals of the two cells are the same. Because there is a fixed mapping relationship between a sequence group and a time-frequency resource position, time-frequency resource positions allocated to a same sequence group are limited, and time-frequency resource positions of reference signals corresponding to the first cell and the second cell may be the same, that is, the time-frequency resource positions used for the reference signals of the first cell and the second cell conflict with each other. Therefore, communication interference is generated between the first cell and the second cell. However, in the method shown in step S603, the time-frequency resource position of the reference signal corresponding to the first cell is updated from the first time-frequency resource position to the second time-frequency resource position, and the first cell and the second cell use different start positions (namely, different time-frequency resource positions), thereby avoiding signal interference.

In a possible design, the second device may predefine N different resource configuration types based on different frequency domain resource density and/or time domain offset values, where N is a positive integer, and the N resource configuration types have different frequency domain resource density and/or time domain offset values. Further, the first device may determine, based on the first resource position parameter, that a resource configuration type used by the first cell is a first resource configuration type. The first resource configuration type is any one of the N resource configuration types. The first device may further determine the second time-frequency resource position based on the first resource configuration type.

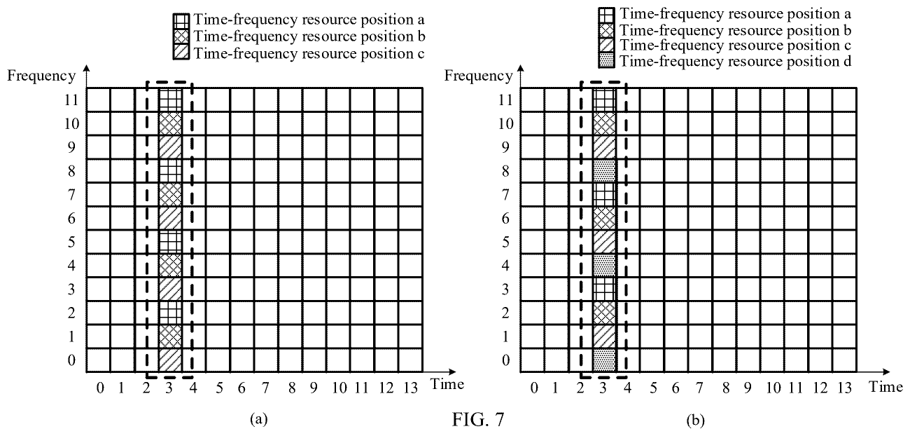

FIG. 7 is an example diagram of a resource configuration type according to this application. In FIG. 7, (a) represents a resource configuration type in which frequency domain resource density is ⅓ and a time domain offset value is three symbols. Clearly, there are three selectable time-frequency resource positions in the resource configuration type. In FIG. 7, (b) represents a resource configuration type in which frequency domain resource density is ¼ and a time domain offset value is three symbols. Clearly, there are four selectable time-frequency resource positions in the resource configuration type. That is, when the frequency domain density of the resource configuration type is reduced to ⅓, the resource configuration type may be reused by three cells, and carrier start positions of the three cells are different. Similarly, when the frequency domain density of the resource configuration type is reduced to ¼, the resource configuration type may be reused by four cells, and carrier start positions of the four cells are different.

In terms of frequency domain, due to flat frequency domain of a satellite channel, sparse pilot density (namely, frequency domain resource density) has little impact on demodulation performance in a communication process. In addition, there is no need to reduce a quantity of ports of each cell, and original frequency domain resources are not changed. Therefore, in the foregoing method for defining N different resource configuration types, a resource configuration type with sparse frequency domain density can be obtained, and time-frequency resource positions of reference signals corresponding to different cells can be coordinated, thereby avoiding communication interference.

Optionally, when a time-frequency resource in the first resource configuration type is reused by a plurality of cells, the second device may further send port indication information. The port indication information indicates information about an available (or unavailable) port of the first cell in the first resource configuration type, and one port corresponds to one time-frequency resource position (one group of time-frequency resource positions). Correspondingly, the first device receives the port indication information from the second device, and the first device may further determine an available (or unavailable) time-frequency resource position of the reference signal of the first cell and/or the reference signal of the second cell based on the port indication information, and determine an antenna port separately used by the first cell and/or the second cell. The port indication information may be sent by using DCI. This is not limited in this application. For an indication method of the port indication information, refer to a conventional technology in the art. This is not limited in this application.

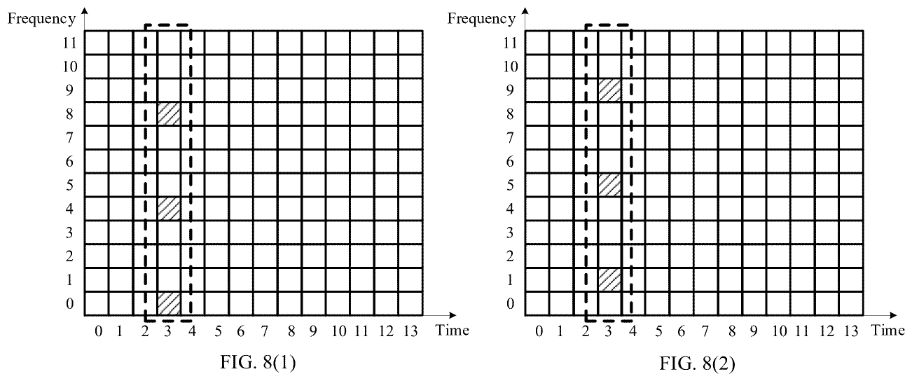

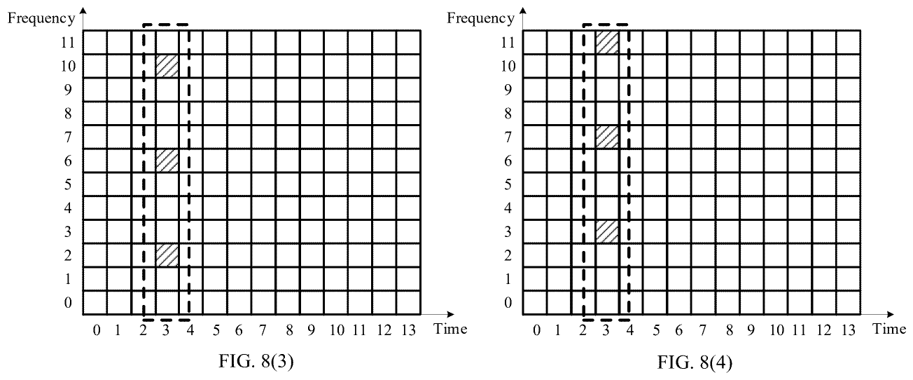

FIG. 8(1) to FIG. 8(4) are an example diagram of a time-frequency resource position according to this application. It is assumed that for the first resource configuration type, frequency domain resource density is ¼, and a time domain offset value is four symbols. In this case, there are four selectable time-frequency resource positions in the resource configuration type, and the time-frequency resource positions respectively correspond to FIG. 8(1), FIG. 8(2), FIG. 8(3), and FIG. 8(4), and may be reused by a maximum of four cells. FIG. 8(1) represents a time-frequency resource whose carrier start position is 4, and an antenna port is 1000; FIG. 8(2) represents a time-frequency resource whose carrier start position is 3, and an antenna port is 1001; FIG. 8(3) represents a time-frequency resource whose carrier start position is 2, and an antenna port is 1002; and FIG. 8(4) represents a time-frequency resource whose carrier start position is 1, and an antenna port is 1003.

Based on the example in FIG. 8(1) to FIG. 8(4), the second device may group time-frequency resources in FIG. 8(1) and FIG. 8(2) into a code division multiplexing (code division multiplexing, CDM) group 0 and a CMD group 1, and allocate the time-frequency resource to the first cell for use (for example, a PCI is 61). A time-frequency resource position (1) corresponds to antenna ports 1000 and 1001, and a time-frequency resource position (2) corresponds to antenna ports 1002 and 1003. The second device may further group time-frequency resources in FIG. 8(3) and FIG. 8(4) into a CDM group 0 and a CDM group 1, and allocate the time-frequency resource to the second cell for use (for example, a PCI is 31). A time-frequency resource position (1) corresponds to antenna ports 1000 and 1001, and a time-frequency resource position (2) corresponds to antenna ports 1002 and 1003.

Further, the first device may determine, based on the first resource configuration type, that a start position of the second time-frequency resource position is any available subcarrier in a first subcarrier to a fourth subcarrier. For example, the first device may further determine, based on the port indication information, that the start position of the second time-frequency resource position is either the first subcarrier or the second subcarrier, that is, any one of the antenna ports 1000 to 1003 in the CDM group 0.

Optionally, a method for determining, by the first device, the resource configuration type used by the first cell includes: The first device determines a resource configuration rule, where the resource configuration rule includes a correspondence between the N resource configuration types and N resource position parameters; and the first device determines, based on the first resource position parameter and the resource configuration rule, that the resource configuration type used by the first cell is the first resource configuration type.

Optionally, the resource configuration rule may be included in the first information, or may be independently transmitted by using second information. That is, the first information includes the resource configuration rule; or the first device may receive the resource configuration rule from the second device.

Optionally, frequency domain resource density of the first resource configuration type is less than or equal to ½, and a time domain offset value of the first resource configuration type is any integer from 1 to 13.

Optionally, the second device may update the time-frequency resource position of the reference signal corresponding to the first cell in a manner the same as that of the first device. Details are not described herein.

S604: The first device sends the first reference signal at the second time-frequency resource position. Correspondingly, the second device receives the first reference signal from the first device at the second time-frequency resource position.

For example, the first device maps the first reference signal and to-be-transmitted data to the second time-frequency resource position, and sends a PUSCH. Correspondingly, the second device receives the first reference signal at the second time-frequency resource position, and demodulates the PUSCH based on the first reference signal, to obtain the to-be-transmitted data.

When there is a modulo conflict between two or more neighboring cells, in principle, only time-frequency resource positions of reference signals of conflicting cells need to be staggered. Therefore, there is no need to update time-frequency resource positions of all conflicting cells. Based on this, this application provides the following designs:

The second device may further send third information, where the third information includes M PCIs (or M (PCI mod i) values) corresponding to M second cells that have a modulo conflict with the first cell and whose time-frequency resource positions do not need to be updated. Correspondingly, the first device receives the third information from the second device. Further, the first device and the second device may separately update the time-frequency resource position of the first cell from the second time-frequency resource position to a third time-frequency resource position based on the M PCIs (or the M (PCI mod i) values) and the second time-frequency resource position.

It should be understood that after the time-frequency resource position is updated, the first device sends the first reference signal at an updated time-frequency resource position (namely, the third time-frequency resource position). Correspondingly, the second device may further receive the first reference signal at the updated time-frequency resource position.

Optionally, the first device and the second device may separately determine a second resource position parameter based on the first resource position parameter and the M PCIs (or the M (PCI mod i) values); and the first device and the second device may further separately determine the third time-frequency resource position based on the second resource position parameter.

A manner of determining the second resource position parameter includes but is not limited to the following two examples:

Example 1: The first device compares the M PCIs with the PCI of the first cell. If PCIs of M₁ second cells are less than the PCI of the first cell, the resource position parameter is recursively shifted forward by M₁. If the PCI of the second cell is greater than or equal to the PCI of the first cell, the resource position parameter of the first cell is not changed. Correspondingly, the third time-frequency resource position may be obtained by recursively shifting the time-frequency resource position of the first cell forward or backward.

When M₁ PCIs in the M PCIs are less than the PCI of the first cell, M₁ is a positive integer, and M₁≤M, M₁, the first resource position parameter, and the second resource position parameter meet the following formula:

$$Second resource position parameter = First resource position parameter - {M}_{1}$$

Example 2: The first device compares the M (PCI mod i) values with (first PCI mod i). When M₂ (PCI mod i) values in the M (PCI mod i) values are less than (first PCI mod i), M₂ is a positive integer, and M₂≤M, M₂, the first resource position parameter, and the second resource position parameter meet the following formula:

$$Second resource position parameter = First resource position parameter - {M}_{2}$$

Optionally, after determining the second resource position parameter, the second device may further send the second resource position parameter to the first device; and the first device determines the third time-frequency resource position based on the second resource position parameter. That is, the first device may obtain the determined second resource position parameter without calculating the second resource position parameter, and then may determine the third time-frequency resource position based on the second resource position parameter.

In such a design, the second device may notify, through broadcast, the M PCIs of the M second cells whose time-frequency resource positions do not need to be updated. The first device may calculate the second resource position parameter or receive the second resource position parameter from the second device, and enable the time-frequency resource position of the first cell to be recursively shifted forward or backward by using an adjusted resource position parameter, thereby saving time-frequency resources.

In the communication method shown in step S601 to step S604, the first device can determine, by using the first resource position parameter (or the second resource position parameter), a time domain resource position for sending the first reference signal, so that the resource position for sending the first reference signal can be changed. This avoids a modulo conflict between the PCI of the first cell and a PCI of a neighboring cell, and reduces uplink signal interference, thereby improving communication performance.

An NTN communication system is used as an example. A constellation (or referred to as a satellite constellation) is a set of satellites that can work normally after being launched into orbit, and is usually a satellite network formed by configuring some satellite rings in a specific manner. The second device is a satellite, and one satellite may manage a plurality of cells. A quantity of PCIs that can be used for allocation in the entire constellation is limited and is only 1008. Therefore, during PCI allocation, if it can be ensured that a quantity of PCIs allocated to each orbital plane in a same constellation is as small as possible, a problem that a modulo conflict occurs between cells on different orbital planes because a limited quantity of PCIs are used up may be avoided as much as possible. A 60*60 constellation and 1008 PCIs are used as an example. To ensure that no modulo conflict occurs between cells on different orbital planes, an upper limit of the quantity of PCIs that can be allocated to each orbital plane is 16. Based on a satellite-specific topology, a PCI of a cell on each orbital plane can be reused provided that a value of a PCI of an intra-satellite cell is different from that of any neighboring cell. For example, when any cell managed by a satellite has a maximum of six neighboring cells, in principle, a plurality of cells managed by the satellite need to reuse only seven PCIs, to avoid a PCI modulo conflict between intra-satellite cells. Based on this, this embodiment of this application further provides the following design:

The second device manages a plurality of cells, and the plurality of cells include the first cell and do not include the second cell that has a modulo conflict with the first cell; and when a topology of the plurality of cells is a regular hexagon, a PCI of each of the plurality of cells is any one of seven values; or when a topology of the plurality of cells is a rectangle, a PCI of each of the plurality of cells is any one of nine values. It should be noted that as a management device of the plurality of cells, the second device may further determine that a value of the PCI of the first cell is different from that of any neighboring cell. This design may be combined with step S401 to step S403, or may be independently used.

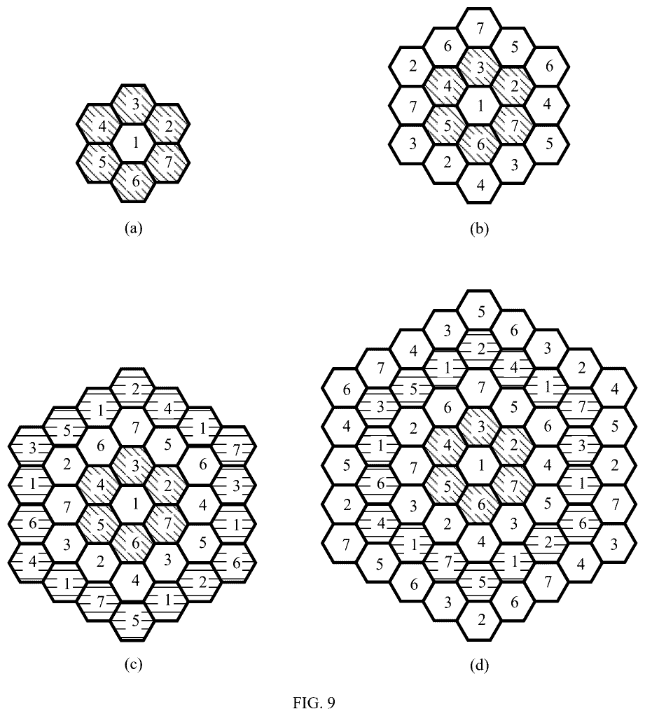

For example, as shown in FIG. 9, when the topology of the plurality of cells is a regular hexagon, the PCI of each of the plurality of cells is any one of the seven values (for example, a fixed set {1, 2, 3, 4, 5, 6, 7}). Further, when a quantity of cells in a single satellite increases, the seven PCIs are always used to deploy all cells. Specifically, when the quantity of cells in the satellite is 7, PCIs of the cells are respectively 1, 2, 3, 4, 5, 6, and 7, as shown in (a) in FIG. 9. Further, when the quantity of cells in the single satellite increases from 7 to 19, the cells in the satellite reuse the seven PCIs, as shown in (b) in FIG. 9. Further, when the quantity of cells in the single satellite is 37, the cells in the satellite still reuse the seven PCIs, as shown in (c) in FIG. 9. Similarly, when the quantity of cells in the single satellite is 61, the cells in the satellite still reuse the seven PCIs, as shown in (d) in FIG. 9. In this way, the satellite always uses the seven PCIs to deploy all cells. This can ensure that each satellite occupies a minimum quantity of PCIs, to avoid a conflict caused due to a same PCI.

Optionally, the first device may determine a PCI of a current cell based on a synchronization signal block (synchronization signal block, SSB). The SSB includes a primary synchronization signal (primary synchronization signal, PSS) and a secondary synchronization signal (secondary synchronization signal, SSS). The first device may further determine whether a satellite ephemeris of a neighboring cell of the current cell includes a PCI the same as a PCI in a fixed set used by a satellite ephemeris of the current cell, to determine a PCI deployment manner used by the plurality of cells of the second device.

In such a design, a PCI is properly reused in a plurality of cells managed by a same satellite, so that a modulo conflict between PCIs in a constellation can be avoided as much as possible without changing an existing PCI standard.

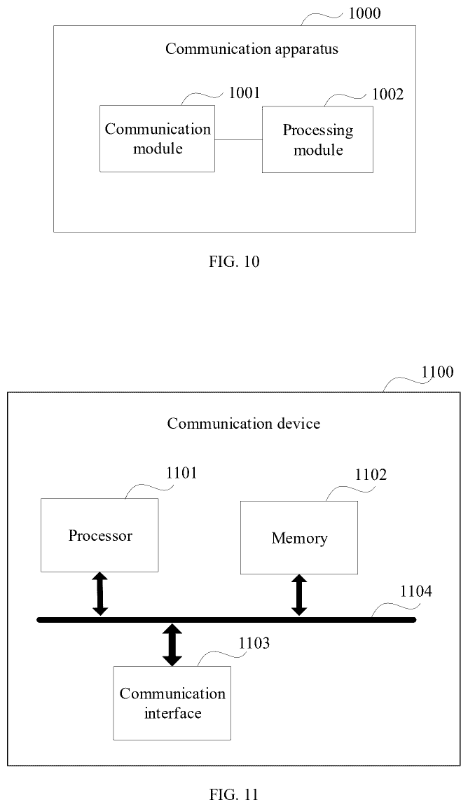

Based on a same technical concept, this application further provides a communication apparatus. The communication apparatus may be used in the communication systems shown in FIG. 1 to FIG. 3, and is configured to implement the communication method provided in the foregoing embodiments. As shown in FIG. 10, a communication apparatus 1000 includes a communication module 1001 and a processing module 1002.

The communication module 1001 is configured to receive and send data. Optionally, the communication module 1001 may include a communication interface.

The processing module 1002 is configured to perform, based on the communication module, the steps performed by the first device or the second device in the communication method provided in the foregoing embodiments. For a specific function of the processing module 1002, refer to the related descriptions in the foregoing embodiments. Details are not described herein.

In an implementation, the communication module 1001 is configured to receive first information from a second device; the processing module 1002 is configured to obtain a virtual PCI of a first cell based on the first information; and the communication module 1001 is further configured to send a first reference signal based on the virtual PCI.

In another implementation, the communication module 1001 sends first information, where the first information is used to obtain a virtual PCI of a first cell, the virtual PCI is different from a PCI of the first cell, and the virtual PCI is different from a physical cell identifier PCI of the first cell; and the communication module 1001 is further configured to receive a first reference signal from a first device, where the first reference signal is sent based on the virtual PCI.

It should be noted that division into the modules in embodiments of this application is an example, and is merely logical function division. In actual implementation, there may be another division manner. In addition, functional units in embodiments of this application may be integrated into one processing unit, or may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the conventional technology, or all or a part of the technical solutions may be implemented in a form of a software product. The computer software product is stored in a storage medium and includes several instructions for indicating a computer device (which may be a personal computer, a server, a second device, or the like) or a processor (processor) to perform all or a part of the steps of the methods in embodiments of this application. The storage medium includes any medium that can store program code, for example, a USB flash drive, a removable hard disk drive, a read-only memory (read-only memory, ROM), a random access memory (random access memory, RAM), a magnetic disk, or an optical disc.

Based on a same technical concept, an embodiment of this application further provides another communication device. The communication device 1100 may implement the communication method provided in the foregoing embodiments, and has a function of the processor provided in the foregoing embodiments. As shown in FIG. 11, the communication device 1100 includes a memory 1102 and a processor 1101. Optionally, the communication device 1100 further includes a communication interface 1103. The communication interface 1103, the processor 1101, and the memory 1102 are connected to each other.

Optionally, the communication interface 1103, the processor 1101, and the memory 1102 are connected to each other through a bus 1104. The bus 1104 may be a peripheral component interconnect (peripheral component interconnect, PCI) bus, an extended industry standard architecture (extended industry standard architecture, EISA) bus, or the like. The bus may be classified into an address bus, a data bus, a control bus, and the like. For ease of representation, only one thick line is used for representation in FIG. 11, but this does not mean that there is only one bus or only one type of bus.

The communication interface 1103 is configured to receive and send data, to implement communication with a device other than the communication device.

For a function of the processor 1101, refer to the descriptions in the foregoing embodiments. Details are not described herein. The processor 1101 may be a central processing unit (central processing unit, CPU), a network processor (network processor, NP), a combination of a CPU and an NP, or the like. The processor 1101 may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable logic gate array (field-programmable gate array, FPGA), generic array logic (generic array logic, GAL), or any combination thereof. The processor 1101 may implement the foregoing function by using hardware or certainly by using hardware executing corresponding software.

The memory 1102 is configured to store program instructions and the like. Specifically, the program instructions may include program code, and the program code includes computer operation instructions. The memory 1102 may include a random access memory (random access memory, RAM), or may further include a non-volatile memory (non-volatile memory), for example, at least one magnetic disk memory. The processor 1101 executes the program instructions stored in the memory 1102, to implement the foregoing function, so as to implement the method provided in the foregoing embodiments. For example, the communication device 1100 may include the first device or the second device shown in embodiments of this application.

Based on a same technical concept, an embodiment of this application further provides a computer program. When the computer program is run on a computer, the computer is enabled to perform the method provided in the foregoing embodiments.

Based on a same technical concept, an embodiment of this application further provides a computer-readable storage medium. The computer-readable storage medium stores a computer program. When the computer program is run on a computer, the computer is enabled to perform the method provided in the foregoing embodiments.

The storage medium may be any usable medium that can be accessed by the computer. The following provides an example but does not impose a limitation. The computer-readable medium may include a RAM, a ROM, an EEPROM, a CD-ROM or another optical disc storage, a magnetic disk storage medium or another magnetic storage device, or any other medium that can be configured to carry or store expected program code in a form of instructions or a data structure and that can be accessed by the computer.

Based on the foregoing embodiments, an embodiment of this application further provides a chip. The chip is configured to read a computer program stored in a memory, to implement the method provided in the foregoing embodiments. Optionally, the chip may include a processor and the memory. The processor is coupled to the memory, and is configured to read the computer program stored in the memory, to implement the method provided in the foregoing embodiments.

Based on the foregoing embodiments, an embodiment of this application provides a chip system. The chip system includes a processor, configured to support a computer apparatus in implementing the function related to the first device or the second device in the foregoing embodiments. In a possible design, the chip system further includes a memory, and the memory is configured to store a program and data that are necessary for the computer apparatus. The chip system may include a chip, or may include a chip and another discrete component.

A person skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to this application. It should be understood that computer program instructions may be used to implement each procedure and/or each block in the flowcharts and/or the block diagrams and a combination of a procedure and/or a block in the flowcharts and/or the block diagrams. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

Alternatively, these computer program instructions may be stored in a computer-readable memory that can direct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

Alternatively, these computer program instructions may be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

Clearly, a person skilled in the art may make various modifications and variations to this application without departing from the spirit and scope of this application. In this way, if these modifications and variations to this application fall within the scope of the claims of this application and their equivalent technologies, this application is also intended to cover these modifications and variations.

What is claimed is:

1. A communication method, wherein the method comprises:
receiving, by a first device, first information from a second device;
obtaining, by the first device, a virtual PCI of a first cell based on the first information, wherein the virtual PCI is different from a physical cell identifier PCI of the first cell; and
sending, by the first device, a first reference signal based on the virtual PCI.

2. The method according to claim 1, wherein the virtual PCI is a sequence group parameter, and sending the first reference signal based on the virtual PCI comprises:
determining, by the first device, a sequence group based on the sequence group parameter; and
sending, by the first device, the first reference signal based on the sequence group.

3. The method according to claim 2, wherein
the sequence group parameter, a preset value i of a modulo conflict, and the sequence group meet the following formula:
$$u = ( {f}_{g h} + {n}_{ID}^{R S} ) mod i ,$$
the mod function is a modulo function, u is the sequence group, f_{gh} is a group frequency hopping function of the sequence group, and
$${n}_{ID}^{R S}$$
is the sequence group parameter.

4. The method according to claim 2, wherein
the first information comprises a value of the sequence group parameter; or
the first information comprises an offset value of the sequence group parameter relative to the PCI of the first cell.

5. The method according to claim 2, wherein the first information is used to trigger calculation of the sequence group parameter, the PCI of the first cell is a first PCI, and the method further comprises:
determining, by the first device, the sequence group parameter based on the first PCI, the preset value i of the modulo conflict, and a preset parameter X, wherein
the sequence group parameter, the preset value i of the modulo conflict, and the first PCI meet the following formula:
$$Sequence group parameter = First PCI + [ First PCI / i ] + X ,$$
wherein
the [ ] function is a rounding function.

6. The method according to claim 1, wherein the virtual PCI is a first resource position parameter, and sending the first reference signal based on the virtual PCI comprises:
updating, by the first device, a time-frequency resource position of a reference signal corresponding to the first cell from a first time-frequency resource position to a second time-frequency resource position based on the first resource position parameter, wherein the second time-frequency resource position is different from the first time-frequency resource position; and
sending, by the first device, the first reference signal at the second time-frequency resource position.

7. The method according to claim 6, wherein
the PCI of the first cell is a first PCI, and the first PCI, a preset value i of a modulo conflict, and the first resource position parameter meet the following formula:
$$First resource position parameter = [ First PCI / i ] + 1 ,$$
the [ ] function is a rounding function.

8. An apparatus, comprising:
at least one processor; and
one or more memories coupled to the at least one processor and storing programming instructions for execution by the at least one processor to:
receive first information from a second device;
obtain a virtual PCI of a first cell based on the first information, wherein the virtual PCI is different from a physical cell identifier PCI of the first cell; and
send a first reference signal based on the virtual PCI.

9. The apparatus according to claim 8, wherein the virtual PCI is a sequence group parameter, and sending the first reference signal based on the virtual PCI comprises:
determining, by the first device, a sequence group based on the sequence group parameter; and
sending, by the first device, the first reference signal based on the sequence group.

10. The apparatus according to claim 9, wherein
the sequence group parameter, a preset value i of a modulo conflict, and the sequence group meet the following formula:
$$u = ( {f}_{g h} + {n}_{ID}^{R S} ) mod i ,$$
wherein
the mod function is a modulo function, u is the sequence group, f_{gh} is a group frequency hopping function of the sequence group, and
$${n}_{ID}^{R S}$$
is the sequence group parameter.

11. The apparatus according to claim 9, wherein
the first information comprises a value of the sequence group parameter; or
the first information comprises an offset value of the sequence group parameter relative to the PCI of the first cell.

12. The apparatus according to claim 9, wherein the first information is used to trigger calculation of the sequence group parameter, the PCI of the first cell is a first PCI, and the one or more memories further storing programming instructions for execution by the at least one processor to:
determine the sequence group parameter based on the first PCI, the preset value i of the modulo conflict, and a preset parameter X, wherein
the sequence group parameter, the preset value i of the modulo conflict, and the first PCI meet the following formula:
$$Sequence group parameter = First PCI + [ First PCI / i ] + X ,$$
the [ ] function is a rounding function.

13. The apparatus according to claim 9, wherein the virtual PCI is a first resource position parameter, and the one or more memories storing programming instructions for execution by the at least one processor to:
update a time-frequency resource position of a reference signal corresponding to the first cell from a first time-frequency resource position to a second time-frequency resource position based on the first resource position parameter, wherein the second time-frequency resource position is different from the first time-frequency resource position; and
send the first reference signal at the second time-frequency resource position.

14. The apparatus according to claim 13, wherein
the PCI of the first cell is a first PCI, and the first PCI, a preset value i of a modulo conflict, and the first resource position parameter meet the following formula:
$$First resource position parameter = [ First PCI / i ] + 1 ,$$
wherein
the [ ] function is a rounding function.

15. An apparatus, comprising:
at least one processor; and
one or more memories coupled to the at least one processor and storing programming instructions for execution by the at least one processor to:
send first information, wherein the first information is used to obtain a virtual PCI of a first cell, and the virtual PCI is different from a PCI of the first cell; and
receive a first reference signal from a first device, wherein the first reference signal is sent based on the virtual PCI.

16. The apparatus according to claim 15, wherein
the virtual PCI is a sequence group parameter, the first reference signal is determined based on a sequence group, and the sequence group is determined based on the sequence group parameter.

17. The apparatus according to claim 16, wherein
the sequence group parameter, a preset value i of the modulo conflict, and the sequence group meet the following formula:
$$u = ( {f}_{g h} + {n}_{ID}^{R S} ) mod i ,$$
wherein
the mod function is a modulo function, u is the sequence group, f_{gh} is a group frequency hopping function of the sequence group, and
$${n}_{ID}^{R S}$$
is the sequence group parameter.

18. The apparatus according to claim 16, wherein
the first information comprises a value of the sequence group parameter; or
the first information comprises an offset value of the sequence group parameter relative to the PCI of the first cell.

19. The apparatus according to claim 16, wherein the PCI of the first cell is a first PCI, the PCI of the second cell is a second PCI, a PCI of a third cell is a third PCI, the preset value i of the modulo conflict indicates a quantity of reference signal combinations, and the method further comprises:
when the modulo conflict between the PCI of the first cell and the PCI of the second cell is a modulo i conflict, determining, by the second device, that the first PCI, the second PCI, the preset value i of the modulo conflict, and the sequence group parameter meet the following formula:
$$( Sequence group parameter mod i ) \neq ( First PCI mod i ) \text{and/or} ( Sequence group parameter mod i ) \neq ( Second PCI mod i ) ;$$
and
when the neighboring cell of the first cell further comprises the third cell, determining, by the second device, that the sequence group parameter, the preset value i of the modulo conflict, and the third PCI meet the following formula:
$$( Sequence group parameter mod i ) \neq ( Third PCI mod i ) .$$

20. The apparatus according to claim 16, wherein the one or more memories further storing programming instructions for execution by the at least one processor to:
determine the sequence group parameter based on the first PCI, the preset value i of the modulo conflict, and a preset parameter X, wherein
the sequence group parameter, the preset value i of the modulo conflict, and the first PCI meet the following formula:
$$Sequence group parameter = First PCI + [ First PCI / i ] + X ,$$
wherein
the [ ] function is a rounding function.
